(19) United States
(12) Patent Application Publication
(10) Pub. No.: US 2017/0013779 A1
(43) Pub. Date: Jan. 19, 2017

(54) Fruits Plucking Device

(71) Applicant: Jason ZHAO, Chino Hills, CA (US)

(72) Inventor: Jason ZHAO, Chino Hills, CA (US)

(21) Appl. No.: 14/803,069

(22) Filed: Jul. 18, 2015

(51) Int. Cl. A01D 46/247; A01D 46/22

(52) U.S. Cl. CPC A01D 46/247; A01D 46/22

(57) ABSTRACT

A fruit plucking device includes a supporting rod and a fruit plucking arrangement. The fruit plucking arrangement includes a plucking frame, a cutting blade and a collector net. The plucking frame is supported on a top portion of the supporting rod, and is configured to form a substantial loop portion. The cutting blade is extended on the plucking frame, and has a sharp cutting edge for cutting fruit. The collector net is provided underneath the plucking frame for collecting the fruit cut by the plucking blade.

### BACKGROUND OF THE PRESENT INVENTION

Field of Invention

The present invention relates to a device for plucking fruit, and more particularly to a fruit plucking device which comprises a fruit plucking arrangement for allowing a user to easily and conveniently harvest and collect fruit on a tree.

Description of Related Arts

A conventional fruit picker usually comprises a supporting pole, and a fruit picker basket supported on top of the supporting pole. The fruit picker basket is usually constructed by several elongated frame members which may be bent to form a basket shape for collecting the fruit. Tongs may be extended from the elongated frame members for plucking fruit on top of a tree.

There are several disadvantages in association with the above-mentioned conventional fruit picker. First, when the fruit are positioned high up a tree, the user of the conventional fruit picker may find it difficult for him to pluck the fruit because the tongs formed on the conventional fruit picker are not effective in cutting fruit.

Second, the length of the supporting pole is not adjustable. As such, it may be inconvenient for a user to use the conventional fruit picker for picking fruit positioned at mid-height. The supporting pole may be too long for allowing a user to exert a suitable amount of force in picking desired fruit, and it may not be suitable for children.

Third, the conventional fruit pick is not flexible enough to pick fruit from a wide range of locations on a tree. For example, some fruit may be prevented from being picked by branches or other obstacles.

Fourth, the fruit picker basket is usually very small and can only accommodate one or two pieces of fruit. As a result, the user must constantly pull the fruit picker basket back to the ground to empty the fruit picker basket before it can accommodate any more fruit.

As a result, there is a need to develop a fruit plucking device which is convenient and easy to use, and is capable of cutting fruit from wide range of locations from a tree.

### SUMMARY OF THE PRESENT INVENTION

An objective of the present invention is to provide a fruit plucking device comprising a fruit plucking arrangement which allows a user to easily and conveniently harvest and collect fruit on a tree.

Another objective of the present invention is to provide a fruit plucking device comprising a supporting rod which has an adjustable length so that a user may optimally adjust the length of the supporting rod for fitting different circumstances.

Another objective of the present invention is to provide a fruit plucking device in which the fruit plucking arrangement comprises a cutting blade for conveniently and easily cutting fruit from a tree.

In one aspect of the present invention, it provides a fruit plucking device, comprising:

a supporting rod; and

a fruit plucking arrangement, which comprises:

a plucking frame supported on a top portion of the supporting rod, the plucking frame being configured to form a substantial loop portion;

a cutting blade extended on the plucking frame, the cutting blade having a sharp cutting edge for cutting fruit; and

a collector net provided underneath the plucking frame for collecting the fruit cut by the plucking blade.

In another aspect of the present invention, it provides a fruit plucking device, comprising:

a supporting rod; and

a fruit plucking arrangement, which comprises:

a plucking frame supported on a top portion of the supporting rod, the plucking frame being configured to form a substantial loop portion, and having a blade portion for cutting fruit; and

a collector net provided underneath the plucking frame for collecting the fruit cut by the blade portion of the plucking frame.

### BRIEF DESCRIPTION OF THE DRAWINGS

FIG. 1 is a perspective view of a fruit plucking device according to a preferred embodiment of the present invention.

FIG. 2 is a side view of the fruit plucking device according to the preferred embodiment of the present invention.

FIG. 3 is a top view of a plucking frame of a fruit plucking arrangement according to the preferred embodiment of the present invention.

FIG. 4 is a front view of an auxiliary cutting blade of the fruit plucking device according to the preferred embodiment of the present invention.

FIG. 5 is an alternative mode of the fruit plucking device according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

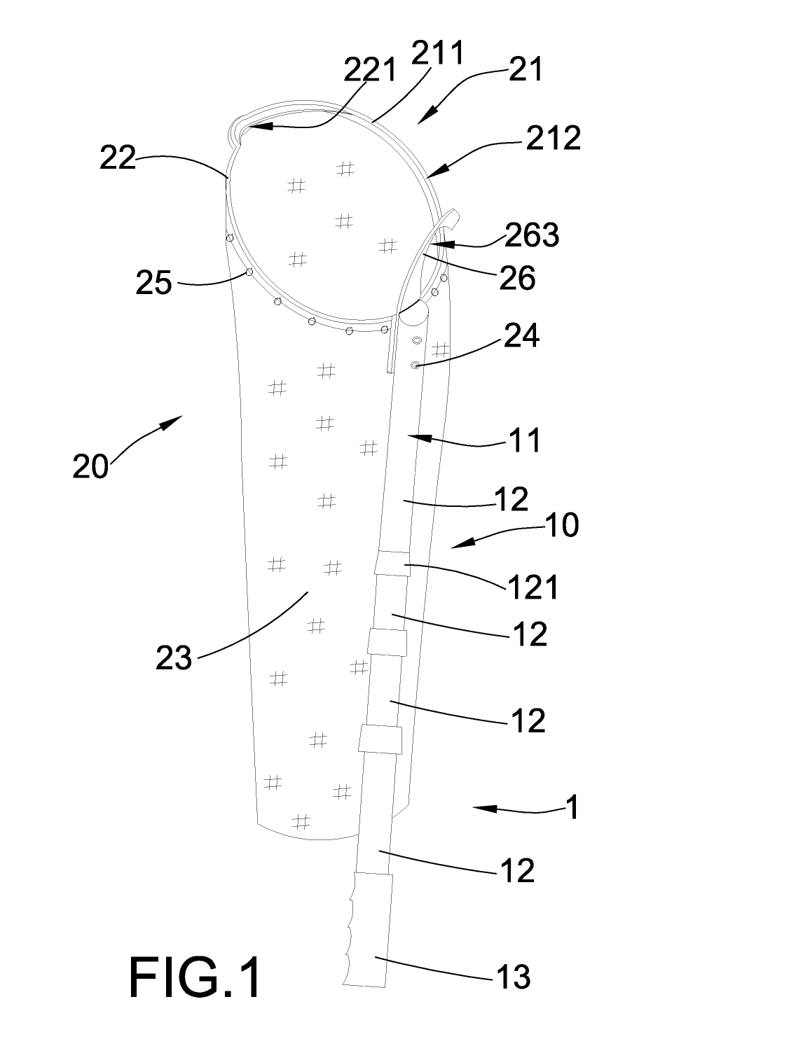

Referring to FIG. 1 to FIG. 3 of the drawings, a fruit plucking device 1 according to a preferred embodiment of the present invention is illustrated. Broadly, the fruit plucking device 1 may comprise a supporting rod 10 and a fruit plucking arrangement 20. The fruit plucking arrangement 20 may comprise a plucking frame 21, a cutting blade 22, and a collector net 23.

The plucking frame 21 may be supported on a top portion 11 of the supporting rod 10. The plucking frame 21 may also be configured to form a substantial loop portion 212. The cutting blade 22 may be extended on the plucking frame 21, and may have a sharp cutting edge 221 for cutting fruit. The collector net 23 may be provided underneath the plucking frame 21 for collecting the fruit cut by the plucking blade 22.

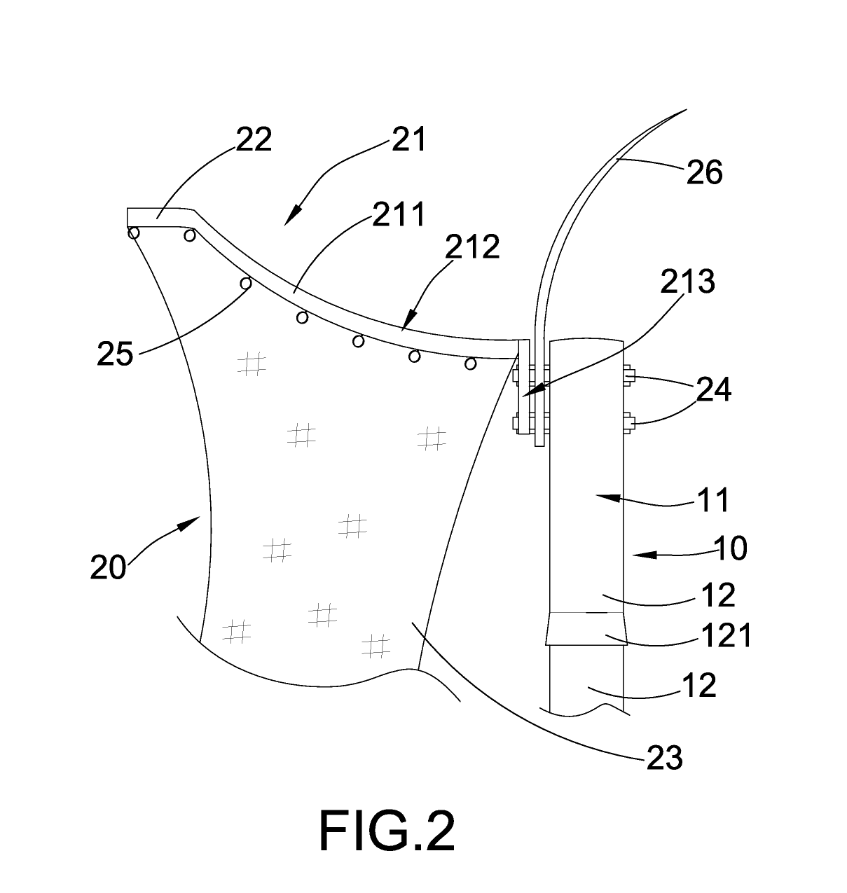

According to the preferred embodiment of the present invention, the supporting rod 10 may comprise a plurality of rod members 12, wherein each of the rod members 12 may be adjustably and slidably connected to at least one other rod member 12 in such a manner that a height of the entire supporting rod 10 may be varied and freely adjusted by a user of the present invention. As shown in FIG. 2 of the drawings, each of the rod members 12 may be configured as a having a tubular structure in which each of an upper rod members 12 may be adjustably inserted into an immediately lower rod member 12. As a result, a diameter of each of the rod members 12 may be gradually decreasing from the bottom-most rod member 12 to the topmost rod member 12. A locking device 121 may be provided between each two rod members 12 so as to adjustably lock up a relative position between each two rod members 12 for maintaining a predetermined length of the entire supporting rod 10. Each of the rod members 12 may have a top bored portion and a bottom threaded portion so that each rod member 12 may be threaded to the immediately bottom rod member 12. The plucking frame 21 may be supported by the topmost rod member 12.

The supporting rod 10 may further comprise a skid-resistance pad 13 formed on an external surface of the bottommost rod member 12. The skid-resistance pad 13 may be ergonomically designed to provide both a secure grip and the maximum comfort to the user of the present invention.

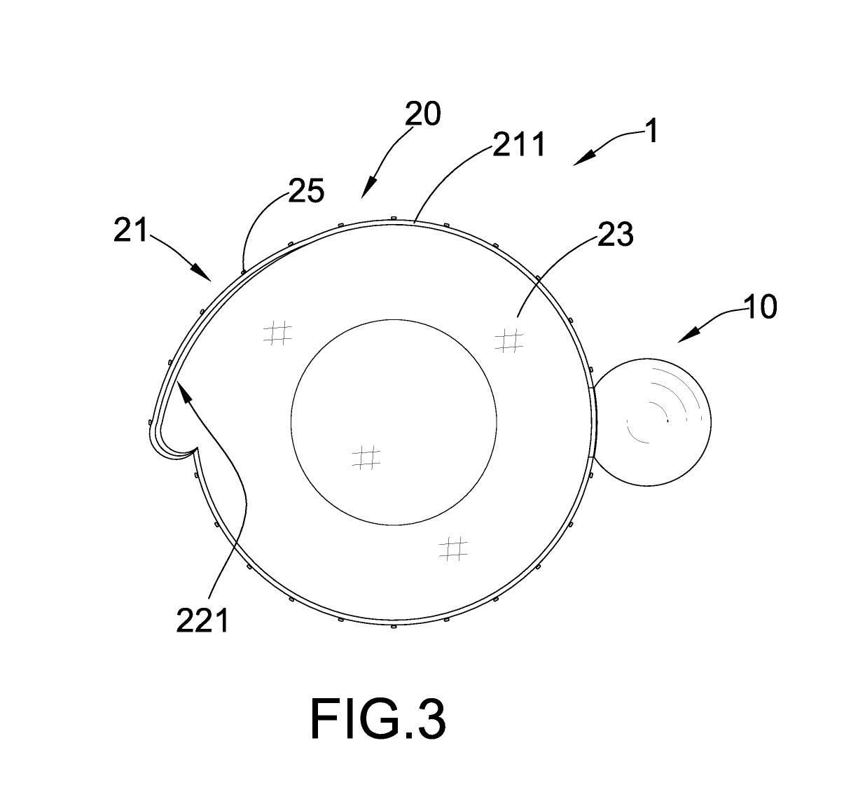

The plucking frame 21 may comprise an elongated frame member 211 which may be bent to form a substantially circular cross sectional shape (see FIG. 3) for forming the loop portion 212 of the plucking frame 21. Furthermore, as shown in FIG. 1 to FIG. 2 of the drawings, the loop portion 212 of the elongated frame member 211 may be extended in an inclined manner from the cutting blade 22 to the supporting rod 10. The reason for this inclined structure of the elongated frame member 211 is that when the cutting blade 22 has cut the fruit from a branch of a tree, the fruit will be naturally guided and fall into the loop. The fruit will then be collected by the collector net 23 and may be safely transported to the ground. The plucking frame 21 may be configured from aluminum alloy so that it is ductile enough and can be easily and conveniently bent into a loop portion 212. One skilled in the art may also appreciate that other suitable materials may also be used to configure the plucking frame 21.

The plucking frame 21 may further have a connecting portion 213 downwardly extended from a lowest side of the loop portion 212 for connecting to the supporting rod 10. The connection between the connecting portion 213 and the supporting rod 10 may be accomplished by two (at least one) connecting screws 24. Each of the connecting screws 24 may have a threaded portion and may be arranged to penetrate the supporting rod 10 and the connecting portion 213 of the plucking frame 21 so as to connect the plucking frame 21 to the supporting rod 10. Screw nuts may be provided for tightening the connecting screws 24.

The fruit plucking arrangement 20 may further comprise a plurality of net holders 25 spacedly provided at a bottom side of the plucking frame 21 for providing support to the collector net 23. Thus, the collector net 23 may be suspendedly connected to the net holders 25 for collecting the fruit cut by the cutting blade 22 and falling in the loop formed by the plucking frame 21. Each of the net holders 25 may be a holding ring attached on the plucking frame 21.

The cutting blade 22 may be attached on a top side or inner side of the plucking frame 21. The cutting blade 22 may be configured as having an elongated structure and an arch cross-sectional shape which corresponds to one cross-sectional sector of the plucking frame 21. Thus, when the cutting blade 22 is attached on the plucking frame 21, the cutting blade 22 may substantially overlap with the corresponding sector of the plucking frame 21. The cutting blade 22 may have the sharp cutting edge 221 formed as a portion of the arch-shaped cutting blade 22. The sharp cutting edge 221 may face inwardly toward the opposed side of the plucking frame 21.

The collector net 23, which may be connected to the net holders 25, may be configured from slightly elastic but durable material such as elasticized nylon material for accommodating fruit of differing shapes and sizes. The collector net 23 has a vertical length which corresponds to the maximum length of the supporting rod 10, and may form an enclosed space for collecting the fruit. Alternatively, the collector net 23 may form an opening at a bottom portion thereof so as to allow the fruit to fall in another container which may be positioned underneath the collector net 23.

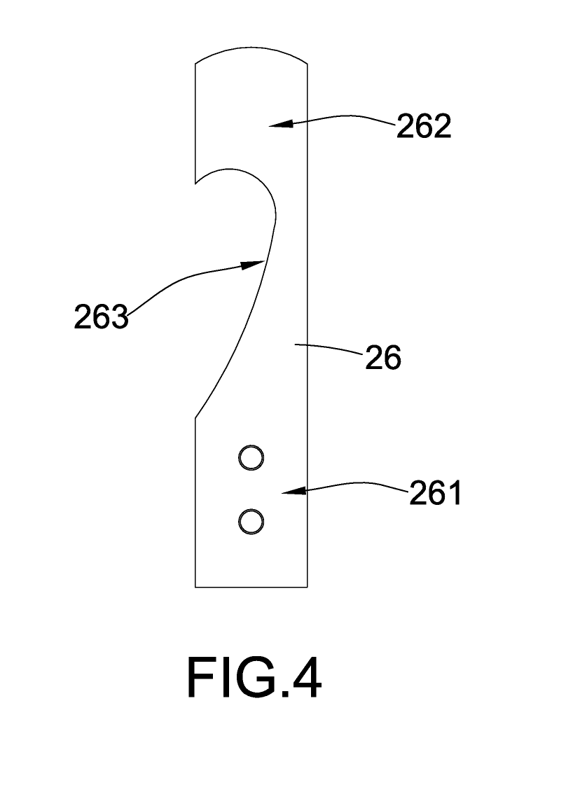

As shown in FIG. 1, FIG. 2 and FIG. 4 of the drawings, the fruit plucking arrangement 20 may further comprise an auxiliary cutting blade 26 upwardly extended from the top portion 11 of the supporting rod 10 for providing additional cutting options for the user of the present invention. Specifically, the auxiliary cutting blade 26 may have an outwardly curved cross sectional shape, and may have a bottom blade portion 261 connected to the connecting screw 24 at a position between the connecting portion 213 of the plucking frame 21 and the top portion 11 of the supporting rod 10. The auxiliary cutting blade 26 may further have an upper blade portion 262 upwardly and outwardly extended from the bottom blade portion 261. A height of the highest point of the auxiliary cutting blade 26 may be higher than that of the plucking frame 21.

FIG. 4 illustrates a front view of the auxiliary cutting blade 26. The auxiliary cutting blade 26 has an auxiliary sharp cutting edge 263 which is inwardly curved to form an indention on the auxiliary cutting blade 26 when viewed from the front. The auxiliary sharp cutting edge 263 may be utilized to cut fruit which are high off the ground.

The curvature of the auxiliary cutting blade 26 and the cutting blade 22 are designed to fit the contours of a wide variety of trees. For example, the auxiliary cutting blade 26 may be suitable for cutting common figs on a tree. The fruit plucking device may also be used to harvest apples, pears, cherries, oranges, limes, lemons, mangos, avocados, plums, etc.

As shown in FIG. 2 of the drawings, the particular configuration of the cutting blade 22 and the auxiliary cutting blade 26 allows fruit to be naturally and optimally collected within the loop structure formed by the plucking frame 21. The curved configuration of the cutting blade 22 and the auxiliary cutting blade 26 follows the contour of branches so that plucking of the fruit can be accomplished conveniently and easily. Moreover, since the overall length of the supporting rod 10 can be adjusted, the present invention may be used by people of different ages and heights.

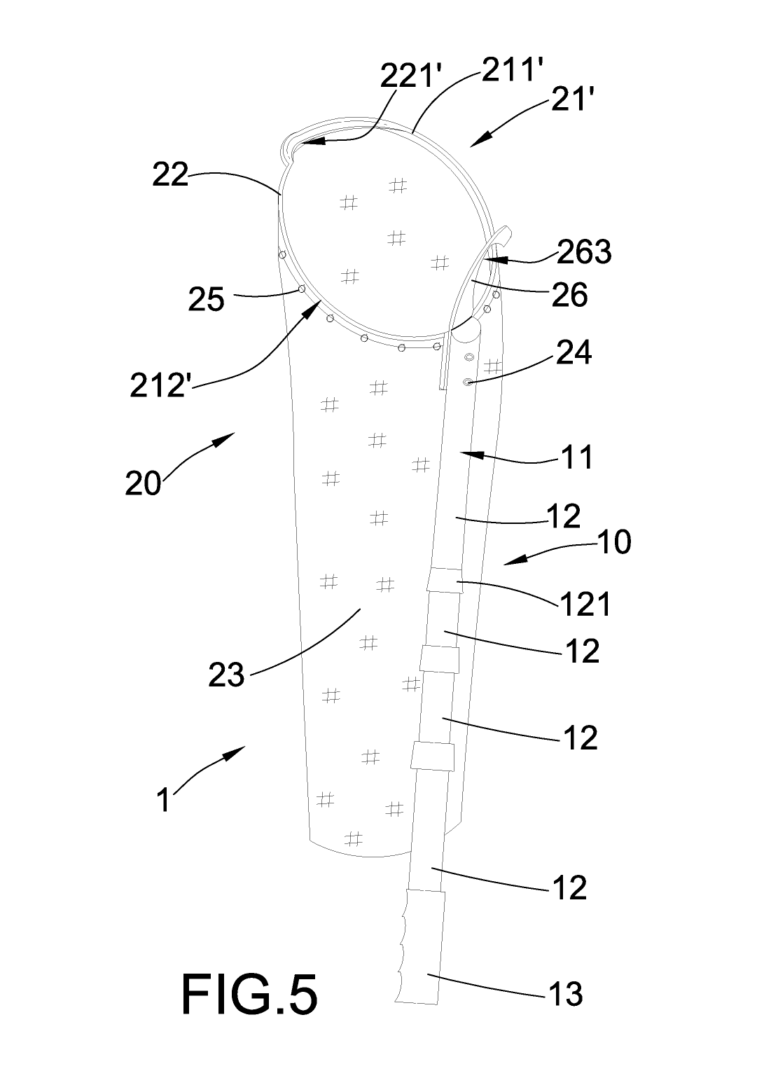

Referring to FIG. 5 of the drawings, an alternative mode of the fruit plucking device according to the preferred embodiment of the present invention is illustrated. The alternative mode is identical to the preferred embodiment, except the plucking frame 21′ and the cutting blade 22. According to the alternative mode, the plucking frame 21′ and the cutting blade 22 form an integral structure.

Specifically, the plucking frame 21′ may also comprise an elongated frame member 211′ which may be bent to form a substantially circular cross sectional shape for forming a loop portion 212′ of the plucking frame 21′. Again, the loop portion 212′ of the elongated frame member 211′ may be extended in an inclined manner from the cutting blade 22′ to the supporting rod 10. The plucking frame 21′ may further have a blade portion 220′ having a sharp cutting edge 221′ formed on the blade portion 220′. The sharp cutting edge 221′ faces inwardly toward the opposed side of the plucking frame 21′.

The alternative mode of the present invention allows the plucking frame 21′ to be easily and conveniently manufactured. The other parts of the plucking frame 21′ remain the same as that disclosed in the preferred embodiment described above.

The present invention, while illustrated and described in terms of a preferred embodiment and several alternatives, is not limited to the particular description contained in this specification. Additional alternative or equivalent components could also be used to practice the present invention.

What is claimed is:

1. A fruit plucking device, comprising:
a supporting rod; and
a fruit plucking arrangement, which comprises:
a plucking frame supported on a top portion of said supporting rod, said plucking frame being configured to form a substantial loop portion;
a cutting blade extended on said plucking frame, said cutting blade having a sharp cutting edge for cutting fruit; and
a collector net provided underneath said plucking frame for collecting said fruit cut by said plucking blade.

2. The fruit plucking device, as recited in claim 1, wherein said plucking frame comprises an elongated frame member bent to form a substantially circular cross sectional shape for forming a loop portion of said plucking frame, said loop portion of said elongated frame member being extended in an inclined manner from said cutting blade to said supporting rod.

3. The fruit plucking device, as recited in claim 2, wherein said cutting blade is attached on said plucking frame, said cutting blade being configured as having an elongated structure and an arch cross-sectional shape which corresponds to one cross-sectional sector of said plucking frame, said cutting blade having said sharp cutting edge formed as a portion of said arch-shaped cutting blade, said sharp cutting edge facing inwardly toward an opposed side of said plucking frame.

4. The fruit plucking device, as recited in claim 3, wherein said fruit plucking arrangement further comprises a plurality of net holders spacedly provided at a bottom side of said plucking frame for providing support to said collector net, said collector net being suspendedly connected to said net holders.

5. The fruit plucking device, as recited in claim 4, wherein said collector net has a vertical length which corresponds to a maximum length of said supporting rod.

6. The fruit plucking device, as recited in claim 5, wherein said plucking frame further has a connecting portion downwardly extended from a lowest side of said loop portion for connecting to said supporting rod.

7. The fruit plucking device, as recited in claim 6, wherein said fruit plucking arrangement further comprises an auxiliary cutting blade upwardly extended from said top portion of said supporting rod, said auxiliary cutting blade having an outwardly curved cross sectional shape, and a bottom blade portion connected between said connecting portion of said plucking frame and said top portion of said supporting rod.

8. The fruit plucking device, as recited in claim 7, wherein said auxiliary cutting blade has an auxiliary sharp cutting edge which is inwardly curved to form an indention on said auxiliary cutting blade.

9. The fruit plucking device, as recited in claim 8, wherein said supporting rod comprises a plurality of rod members, wherein each of said rod members is adjustably and slidably connected to another rod member in such a manner that a height of said entire supporting rod is capable of being adjusted.

10. The fruit plucking device, as recited in claim 9, wherein each of said rod members is configured as a having a tubular structure in which each of an upper rod members is adjustably inserted into an immediately lower rod member, a diameter of each of said rod members is gradually decreasing from a bottommost rod member to a topmost rod member.

11. A fruit plucking device, comprising:
a supporting rod; and
a fruit plucking arrangement, which comprises:
a plucking frame supported on a top portion of said supporting rod, said plucking frame being configured to form a substantial loop portion, and having a blade portion for cutting fruit; and
a collector net provided underneath said plucking frame for collecting said fruit cut by said blade portion of said plucking frame.

12. The fruit plucking device, as recited in claim 11, wherein said plucking frame comprises an elongated frame member bent to form a substantially circular cross sectional shape for forming a loop portion of said plucking frame, said loop portion of said elongated frame member being extended in an inclined manner from said cutting blade to said supporting rod.

13. The fruit plucking device, as recited in claim 12, wherein said plucking frame further has a blade portion having a sharp cutting edge, said sharp cutting edge facing inwardly toward an opposed side of said plucking frame.

14. The fruit plucking device, as recited in claim 13, wherein said plucking frame further has a connecting portion downwardly extended from a lowest side of said loop portion for connecting to said supporting rod.

15. The fruit plucking device, as recited in claim 14, wherein said fruit plucking arrangement further comprises a plurality of net holders spacedly provided at a bottom side of said plucking frame for providing support to said collector net, said collector net being suspendedly connected to said net holders.

16. The fruit plucking device, as recited in claim 15, wherein said collector net has a vertical length which corresponds to a maximum length of said supporting rod.

17. The fruit plucking device, as recited in claim 16, wherein said fruit plucking arrangement further comprises an auxiliary cutting blade upwardly extended from said top portion of said supporting rod, said auxiliary cutting blade having an outwardly curved cross sectional shape, and a bottom blade portion connected between said connecting portion of said plucking frame and said top portion of said supporting rod.

18. The fruit plucking device, as recited in claim 17, wherein said auxiliary cutting blade has an auxiliary sharp cutting edge which is inwardly curved to form an indention on said auxiliary cutting blade.

19. The fruit plucking device, as recited in claim 18, wherein said supporting rod comprises a plurality of rod members, wherein each of said rod members is adjustably and slidably connected to another rod member in such a manner that a height of said entire supporting rod is capable of being adjusted.

20. The fruit plucking device, as recited in claim 19, wherein each of said rod members is configured as a having a tubular structure in which each of an upper rod members is adjustably inserted into an immediately lower rod member, a diameter of each of said rod members is gradually decreasing from a bottommost rod member to a topmost rod member.
